(19) United States
(12) Patent Application Publication
(10) Pub. No.: US 2023/0005024 A1
(43) Pub. Date: Jan. 5, 2023

(54) ADVERTISEMENT SERVING AND TRANSACTION SYSTEMS AND METHODS

(71) Applicant: Matthew M. McLean, Boston, MA (US)

(72) Inventor: Matthew M. McLean, Boston, MA (US)

(21) Appl. No.: 17/857,209

(22) Filed: Jul. 5, 2022

Related U.S. Application Data
(60) Provisional application No. 63/218,187, filed on Jul. 2, 2021.

(51) Int. Cl. G06Q 30/02

(52) U.S. Cl. CPC G06Q 30/0274

(57) ABSTRACT

An advertisement (Ad) serving system including a media content server arranged to: receive media content; receive an electronic advertisement; receive a consumer Ad payment limit; receive an advertiser Ad payment limit; compare the consumer Ad payment limit to the advertiser Ad payment limit and when a second advertiser Ad payment limit is not received: if the consumer Ad payment limit is greater than or equal to the advertiser Ad payment limit, output the media content, and if the consumer Ad payment limit is less than the advertiser Ad payment limit, output the media content with the electronic advertisement. The system also includes a consumer client device arranged to: transmit the consumer Ad payment limit to the media content server, receive the media content from the content server, and receive the electronic advertisement with the media content when the consumer Ad payment limit is less than the advertiser Ad payment limit.

### REFERENCE TO RELATED APPLICATIONS

This application claims priority to and the benefit of U.S. Provisional Patent Application No. 63/218,187, filed on Jul. 2, 2021, entitled “System to Improve Advertising Transactions for all Stakeholders,” the entire contents of which are incorporated herein by reference.

### TECHNICAL FIELD

This application relates generally to electronic advertisement delivery systems and, more particularly, to conditional delivery of electronic advertisements with media content.

### BACKGROUND

Content is typically monetized with advertising using two two-party transactions. The “Content Producer” gives content to a “Content Consumer”. The “Content Consumer” gives their attention to an “Advertiser” and the “Advertiser” gives money to the “Content Producer.”

In the first transaction the “Content Producer” exchanges content for the attention of the “Content Consumer”. In the second transaction the “Content Producer” sells the consumer's attention to an “Advertiser”. This is illustrated in FIG. 1A. In this example, the “Content Consumer's” attention is the product in the second transaction.

There are problems for all three stakeholders with existing Ad serving systems. The “Content Producer” is often dissatisfied with the amount of money the advertising market is willing to pay for the consumer's attention. The “Content Consumer” often values the time it “costs” to watch an advertisement more than they value the content they are receiving in exchange. This results in the consumer skipping the content experience to the detriment of all stakeholders. The “Advertiser” is often doing damage to its brand by polluting the culture with ineffective ads.

Using the national minimum wage of $7.25/hour as a guide, a consumer's time is worth 12 cents a minute. Ad market rates that pay fractions of a cent per view are valuing the consumer's attention at less than 1 penny per minute. This disparity is exacerbated if the “Content Consumer” values their time at a rate hirer that $7.25/hour. Because there is exponentially more content produced than advertisers willing to advertise, the price the “Advertiser” pays to the “Content Producer” is lower than the value of the content to “Content Producers” and “Content Consumers.”

FIGS. 1A and 1B shows existing media content delivery models that are unsatisfactory to media content providers, consumers, and advertisers. FIG. 1 shows an Ad serving model 100 where a content provider/producer 102 receives a payment from and advertiser 106 (Step 1) in exchanges for consumer 104's attention (Steps 3 and 4) when the consumer receives media content (Step 2). The consumer's attention is typically in the form of viewing an electronic Ad that is sent to the consumer 104. The electronic Ad may have a duration of 5 seconds to 30 seconds, or longer. None of the parties 102, 104, and 106 are satisfied with model 100 because the consumer 104 is forced to watch an electronic Ad for a period of time, i.e., the consumer's attention is distracted from the desired media content for a period of time. This may create a negative impression by the consumer 104 of the advertiser 106 and/or advertiser's product. Furthermore, the consumer 104 may not request further content from the media content provider 102 in the future, resulting in lost revenue to the media content provider 102.

FIG. 1B shows an alternative existing model 150 where the consumer 104 purchases a subscription to media content from the media content provider 102 (Step 1). In exchange, the media content provider 102 delivers the media content without an Ad (Step 2). For example, the consumer 104 may purchase access to NETFLIX, Disney+, the New York Times, and so on. Unfortunately, the consumer 104 may only desire access to a small amount of media content, e.g., movies, shows, articles, videos. The consumer is forced to overpay for additional unwanted content. The advertiser 106 is completely excluded from any opportunity to provide an Ad and obtain the target consumer's attention.

Unfortunately, none of the existing Ad serving systems or models provide a way to serve Ads and facilitate related transactions in a way that enables efficient distribution of media content with electronic advertisements that is satisfying to all three parties to a media content delivery transaction such as the consumer, advertiser, and the media content provider/producer.

### SUMMARY

The application addresses deficiencies associated with the existing advertisement servicing systems and models by, in various implementations, recognizing that advertising serving involves a three-party transaction among stakeholders including the content producer of the media content, an advertiser, and consumer of the media content. For harmony to exist in the ad market, all of the stakeholders need to agree to the value of what is being traded. The reason consumers and advertisers wildly disagree on the value of the consumer's time is because the consumer is not able to participate in the market for their own time. By allowing the consumer to participate in the market for their own time, i.e., decide whether to view an electronic Ad, the three things being traded (money, content, and consumer attention) begin to be valued in a similar way by all parties.

Advertising is sold in units of 1000 views, (Cost Per Thousand or CPM). A CPM of $5 means the advertiser is paying one half penny per view. In one example. the “Advertiser” bids one penny for the “Content Consumer's” attention. If the “Content Consumer” values the media content at more than one penny but less than the cost of 15 seconds of time to watch the Ad, they can bid more than one penny in the ad market, pay directly to the “Content Producer,” and skip viewing the Ad. In this example, the “Content Producer” benefits from a higher price and the “Content Consumer” benefits from a lower cost. The “Advertiser” benefits from avoiding damage done to their brand from the resentment from the other two stakeholders. People watching interruption advertising value their units of attention in an exponential way. Other stakeholders in the market might be tempted to value 30 seconds of consumer attention at 6 times the value of 5 seconds of consumer attention, but to the content consumer 30 seconds costs exponentially more than 5 seconds of attention.

In a second example, the advertiser bids a dollar per viewer for a desirable audience. The viewer values the content at less than the dollar bid but more than 15 second “cost” in their own time watching the ad. This viewer would choose to watch the 15 second Ad and the “Advertiser” would pay one dollar to the “Content Producer.” In this second example, the “Advertiser” would develop goodwill with the “Content Consumer” by paying for wanted content. The “Content Consumer” would receive media content they valued more than their 15 seconds of their time, and the “Content Producer” would benefit from the higher price they receive because of the new competition for the consumer's attention.

A monopoly is a market where a single producer has the ability to influence the price of goods or services because the consumer has no other choice. There is no competition among producers. A monopsony is a market where a single consumer has the ability to influence the price of goods or services because the producers have no other choice. An example of a monopsonistic market is a single employer, like a coal mine, that employs an entire region of employees. Many producers of labor but only one consumer of labor. A lack of competition in that situation gives the coal mine an unfair ability to determine the price of labor.

Advertising markets are neither a monopoly or a monopsony. There are many people willing to trade their attention and many advertisers willing to buy that attention. However, advertising markets behave in a similar way to monopsonistic markets because content producers and advertisers typically view all consumer's attention and/or time as having the same value. By introducing competition for the consumer's time, the consumer's time, i.e., what is being traded, can be valued equally by all stakeholders.

This application describes exemplary systems and methods that allow for responses to the market from all stakeholders. For example, a newspaper could make an article available to non-subscribers for a specific minimum price and leave it to the advertiser and consumer to bid against each other.

The disclosure describes, in some implementations, an electronic bidding system having a media content provider and/or producer that facilitates a bidding process between a consumer client device and advertiser server for the consumer's attention related to an advertisement. An advertiser server may submit an advertiser bid, e.g., an advertiser Ad payment limit, and a consumer device may submit a consumer bid, e.g., a consumer Ad payment limit, to a content provider server. If the consumer outbids the advertiser, then the consumer pays the content producer directly. If the advertiser wins the bid for the consumer's attention, then the advertiser pays the media content producer and the consumer watches the Ad.

Consumers such as consumer 104 could predetermine how much money or time they are willing to pay for media content that they value and assign different amounts for different levels of subjective value to them. Advertisers such as advertiser 106 could assign different bid amounts based on the media content and demographics of the consumer 104.

In one aspect, an advertisement (Ad) serving system includes a media content server arranged to: receive media content from a media database, receive an electronic advertisement from an advertisement database, receive a consumer Ad payment limit; receive an advertiser Ad payment limit. The system compares the consumer Ad payment limit to the advertiser Ad payment limit and when a second advertiser Ad payment limit is not received: if the consumer Ad payment limit is greater than or equal to the advertiser Ad payment limit, then output the media content, or if the consumer Ad payment limit is less than the advertiser Ad payment limit, then output the media content with the electronic advertisement. The system also includes a consumer client device arranged to: transmit the consumer Ad payment limit to the media content server, receive the media content from the content server, and receive the electronic advertisement with the media content when the consumer Ad payment limit is less than the advertiser Ad payment limit.

The media content server may include a web server. The consumer client device may include a web client. The system may include an advertiser server configured to send at least one of the advertiser Ad payment limit and the second advertiser Ad payment limit to the media content server. The advertiser server may be configured to receive the consumer Ad payment limit from the media content server. The advertiser server may send the second advertiser Ad payment limit to the media content server in response to the received consumer ad payment limit.

The consumer client device may be configured to receive the advertiser Ad payment limit from the media content server. The consumer client device may send a second consumer Ad payment limit to the media content server in response to the received advertiser Ad payment limit. The second consumer Ad payment limit may be greater than the received advertiser payment limit. The second advertiser Ad payment limit may be greater than the consumer Ad payment limit.

In another aspect, a media content server including a transceiver arranged to: receive media content from a media database, receive an electronic advertisement from an advertisement database, receive a consumer Ad payment limit from a consumer client device, and receive an advertiser Ad payment limit from an advertising server. The server also includes a processor, in communications with the transceiver, arranged to compare the consumer Ad payment limit to the advertiser Ad payment limit. When a second advertiser Ad payment limit is not received: if the consumer Ad payment limit is greater than or equal to the advertiser Ad payment limit, then output the media content to the consumer client device, and if the consumer Ad payment limit is less than the advertiser Ad payment limit, then output the media content with the electronic advertisement to the consumer client device.

The transceiver may be configured to receive the second advertiser Ad payment limit from the advertiser server. The transceiver may be configured to send the consumer Ad payment limit to the advertiser server. The transceiver may receive the second advertiser Ad payment limit in response to sending the consumer ad payment limit to the advertiser server. The consumer Ad payment limit may be set based on a first Ad payment category and a second consumer Ad payment limit may be set based on a second Ad payment category. The advertiser Ad payment limit may be set based on consumer demographic data.

In another aspect, a non-transient computer readable medium containing program instructions for causing a computer to implement Ad serving includes the method of: receiving media content from a media database; receiving an electronic advertisement from an advertisement database; receiving a consumer Ad payment limit from a consumer client device; receiving an advertiser Ad payment limit from an advertiser server; and comparing the consumer Ad payment limit to the advertiser Ad payment limit and when a second advertiser Ad payment limit is not received:
if the consumer Ad payment limit is greater than or equal to the advertiser Ad payment limit, then outputting the media content, and
if the consumer Ad payment limit is less than the advertiser Ad payment limit, then outputting the media content with the electronic advertisement.

Media content may include text, images, audio, video, animation, and/or multimedia data files that can be played and/or output on a consumer client device and/or text, images, audio, video, animation, and/or multimedia that is streamed to and/or played or output on a consumer client device. An electronic advertisement or Ad is a type of media content that promotes, includes information about, and/or attempts to sell a product and/or service. Types of video file formats may include, without limitation, MOV, MP4, AVI, WMF, FLV, WebM, and OGG. Types of image file formats include, without limitation, JPEG, JPG, JPEG 2000, GIF, PNG, BMP, RAW, TIFF, PSD, and CR2. Types of audio file formats include, without limitation, PCM, WAV, AIFF, MP3, ACC, OGG (Vorbis), windows media audio (WMA), FLAC, ALAC, and WMA (lossless).

Various aspects of the systems and methods are directed to one or more inventive concepts. In certain implementations, the above aspects should be considered directed to an Internet-centric problem or improvement of computer technology related to selectively distribution of electronic advertisements with media content that advantageously and directly involves the multiple entities in an Internet process. The present aspects are directed to an inventive concept of enabling consumers and advertisers to compete for a consumer's attention to view an electronic advertisement associated with the delivery of media content from a media content provider in a more efficient, selective, and satisfying manner among each of the multiple entities via the Internet and other networks or electronic media.

Even if additional features of the above aspects, when viewed individually, were to be considered generic computer and networking functions, an inventive concept exists because of the unconventional and non-generic combination of known elements, including enabling multiple independent entities to coordinate electronically to facilitate whether a media content consumer will be presented with an electronic advertisement when viewing media content. Such selective, efficient, and cooperative electronic arbitration among an advertiser, consumer, and media content provider represents a synergistic solution to a technical problem of how to efficiently and conditionally distribute electronic advertisements to consumers. Furthermore, the various features and limitations of the above aspects should confine any abstract idea to a particular and practical application such that the combination of features is not a well-understood, routine, or conventional activity. Also, the need to efficiently and timely implement features of the above aspects require operations to be performed via computing processes, as it would not be practically possible to implement such aspects via human activities alone.

Any two or more of the features described in this specification, including in this summary section, may be combined to form implementations not specifically described in this specification.

The details of one or more implementations are set forth in the accompanying drawings and the following description. Other features and advantages will be apparent from the description and drawings, and from the claims.

### DESCRIPTION OF THE DRAWINGS

FIGS. 1A and 1B are conceptual diagrams of two separate two-party transactions associated with serving media content and an advertisement to a consumer client device;

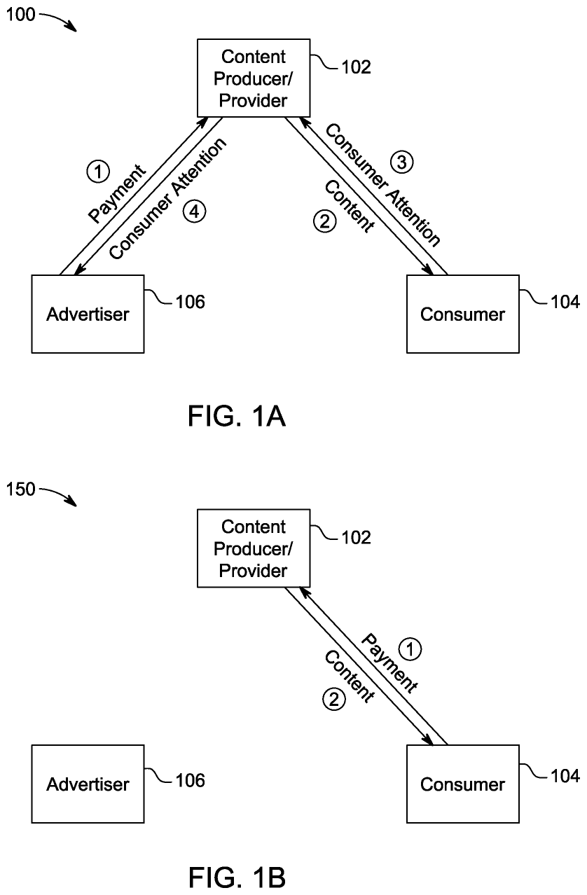

FIG. 2 is a conceptual diagram of a bidding process between a consumer and advertising for the consumer's attention related to an advertisement;

FIG. 3 is an illustration of an Ad serving and media content distribution network;

FIG. 4 is block diagram of a computer system arranged to perform processing associated with an Ad serving system;

FIG. 5 is a block diagram of an Ad serving system;

FIG. 6 shows an exemplary process for determining whether to output media content with an electronic advertisement;

Like reference numerals in different figures indicate like elements.

### DETAILED DESCRIPTION

The application, in various aspects, addresses deficiencies associated with conditional advertisement serving and transaction systems and methods. The application includes exemplary systems, methods, devices that facilitate a bidding process between a consumer device and advertising device for the consumer's attention related to an advertisement to enable more efficient, fair, and satisfying serving of electronic advertisements to consumer devices.

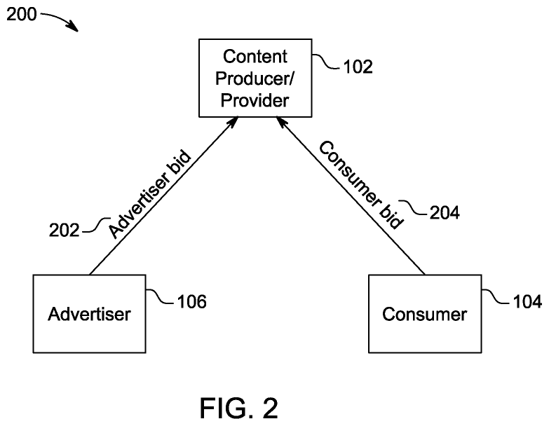

FIG. 2 is a conceptual diagram of a bidding system 200 including a media content provider and/or producer 102 that facilitates a bidding process between a consumer 104 and advertiser 106 for the consumer's attention related to an advertisement. In system 200, advertiser 106 submits an advertiser bid 202, e.g., an advertiser Ad payment limit, and consumer 104 submits a consumer bid 204, e.g., a consumer Ad payment limit, to a content provider 102. If the consumer 104 outbids the advertiser 106, then the consumer 104 pays the content producer 102 directly. If the advertiser 106 wins the bid for the consumer's attention, then the advertiser 106 pays the media content producer 102 and the consumer 104 watches the Ad.

Consumers such as consumer 104 could predetermine how much money or time they are willing to pay for media content that they value and assign different amounts for different levels of subjective value to them. Advertisers such as advertiser 106 could assign different bid amounts based on the media content and demographics of the consumer 104.

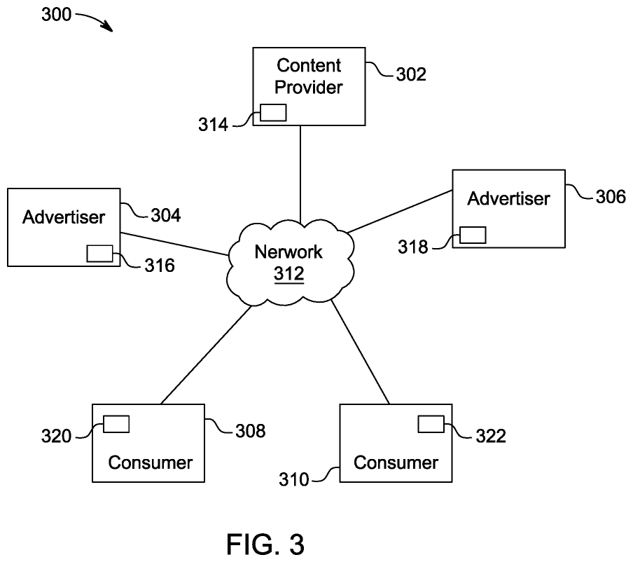

FIG. 3 is an illustration of an Ad serving and media content distribution system 300. System 300 includes a media content provider/producer server 302, an advertiser server 304, advertiser server 306, consumer client device 308, and consumer client device 310. Media content provider sever 302 may include an arbitrator application 314, which may include a web server application. Advertiser server 304 and advertiser server 306 may include an arbitrator client application 316 and arbitrator client application 318 respectively. Client devices 316 and 318 may include web clients and/or browsers capable of interfacing with arbitrator application 314. Network 312 facilitates electronic communications between the entities connected to network 312. Consumer client devices 308 and 310 may include any type of computing device such as, without limitation, a personal computer (PC), mobile computing device, mobile telephone, multimedia device, television, NextGen TV (e.g., ATSC 3.0), data streaming device, and any device capable of receiving and playing media content and/or electronic advertisements.

System 300 may operate as an Ad serving system including media content server 302 that is arranged to: receive media content; receive an electronic advertisement from an advertiser such as via advertiser server 304 and/or 306; receive a consumer Ad payment limit from a consumer via consumer device 308 and/or 310; and receive an advertiser Ad payment limit via advertiser server 304 and/or 306. Media content server 302 may then compare the consumer Ad payment limit to the advertiser Ad payment limit and if the consumer Ad payment limit is greater than or equal to the advertiser Ad payment limit, then output the media content without an Ad to the consumer client device 308 or 310 that requested the media content and made the consumer bid, i.e., submitted the consumer Ad payment limit. If the consumer Ad payment limit is less than the advertiser Ad payment limit, then the media content server 302 outputs the media content with the electronic Ad. A consumer client device such as device 308 may be arranged to: transmit the consumer Ad payment limit to the media content server 302, receive the media content from the content server 302, and receive the electronic Ad with the media content when the consumer Ad payment limit is less than the advertiser Ad payment limit.

In some implementations, an advertiser server, e.g., server 304, may engage in a bidding process with a consumer device, e.g., device 308, to determine whether media content sent to the consumer device 308 should include an electronic Ad. Hence, an advertiser server 304 and/or 306 may be configured to send one or more advertiser Ad payment limits to the media content server 302. For example, the advertiser server 304 and consumer client device 308 may bid and counterbid with each other until a final one of the parties has the highest bid. The advertiser server 304 wins when the final advertiser Ad payment limit is greater than a final consumer Ad payment limit. The consumer client device 308 wins when the final consumer Ad payment limit is greater than or equal to the final advertiser Ad payment limit. In other words, when the content server 302 does not receive from an advertiser Ad payment limit in response to and greater than the latest consumer Ad payment limit sent from the consumer device 308, then the latest and/or final consumer Ad payment limit wins. In this implementation, the ties goes to the consumer client device 308. In other implementations, the tie can go to the advertiser server 304.

A consumer may use their web browser running on client device 308 to watch a home improvement video on YouTube, e.g., media content server 302. At some point while the video is playing, a 20 second electronic advertisement may be designated to be played. The advertisement may be for a window product from a window manufacturer via advertiser server 304. Arbitrator application 314 of media content server 302 compares the advertiser Ad payment limit which may be 10 cents for the 20 second video with the consumer Ad payment limit which may be 20 cents. The arbitrator application 314 determines that the consumer Ad payment limit is greater than the advertiser Ad payment limit and skips or removes the advertisement from the video being played so that the consumer avoids watching the electronic advertisement. The consumer also pays YouTube, e.g., the media content server 302 the 20 cents to skip the electronic advertisement.

In some implementations, the media content server 302 and/or arbitrator application 314 includes a user portal arranged to receive payment information from a consumer. The portal may include a web server interface that interfaces with a web browser and/or arbitrator client application 320 of a consumer client device 308. The consumer may be able to set up an account with YouTube via the portal that enables the user to input Ad serving configuration settings such as a consumer Ad payment limit to be applied when skipping electronic advertisements associated with media content viewed on the YouTube website. The portal may also enable an advertiser using an arbitrator client 316 of advertiser server 304 to set up an account with the media server 302, e.g., YouTube server, via the portal that enables the advertiser to input Ad serving configuration settings such as an advertiser Ad payment limit to be applied for electronic advertisements that are played associated with media content viewed on the YouTube website.

In some implementations, multiple advertisers may simultaneously or concurrently bid against a consumer for the consumer's time to view an Ad. For example, advertiser server 304 associated with a first advertiser may bid 10 cents to present a first Ad to a consumer while advertiser server 306 associated with a second advertiser may bid 25 cents to present a second Ad to the consumer. If the consumer bid is 20 cents, then the consumer wins against the first advertiser but loses against the second advertiser, in which case, the consumer views the second Ad and the second advertiser pays the media content provider via media content server 302. In some implementations, media content server 302 and/or arbitrator application 314 determine in real-time whether to skip or play an advertisement and/or which advertisement to display among multiple Ads.

In some implementations, the arbitrator application 314 is preconfigured with the consumer Ad payment limit and the advertiser Ad payment limit, and performs the comparison either before or in real-time as the Ad is expected to be delivered to and/or played by a consumer device and/or client application. In other implementations, the arbitrator application 314 requests and/or retrieves the consumer Ad payment limit and/or the advertiser Ad payment limit from the arbitrator client 320 and/or 316 in real-time before comparing the values and determining whether an advertisement will be delivered to a consumer client device with a media content item.

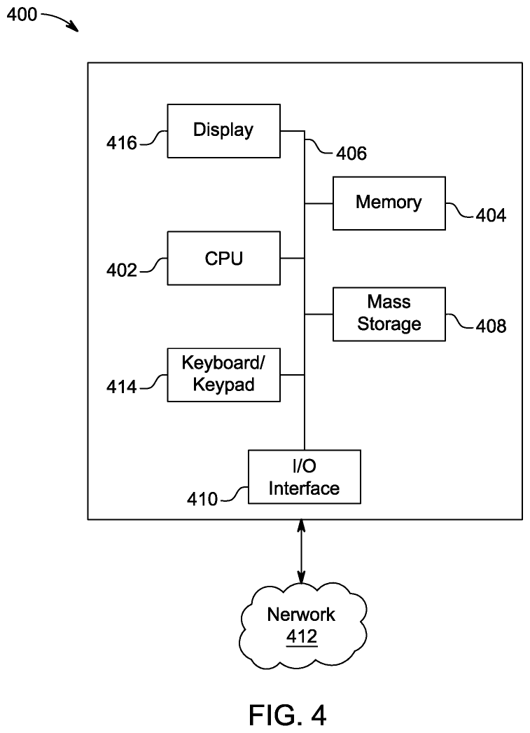

FIG. 4 is block diagram of a computer system 400 arranged to perform processing associated with an Ad serving system. The exemplary computer system 400 includes a central processing unit (CPU) 402, a memory 404, and an interconnect bus 406. The CPU 402 may include a single microprocessor or a plurality of microprocessors or special purpose processors for configuring computer system 400 as a multi-processor system. The memory 404 illustratively includes a main memory and a read only memory. The computer 400 also includes the mass storage device 408 having, for example, various disk drives, solid state drives, tape drives, etc. The memory 404 also includes dynamic random-access memory (DRAM) and high-speed cache memory. In operation, memory 404 stores at least portions of instructions and data for execution by the CPU 402. The memory 404 may also contain compute elements, such as Deep In-Memory Architectures (DIMA), wherein data is sent to memory and a function of the data (e.g., matrix vector multiplication) is read out by the CPU 402.

The mass storage 408 may include one or more magnetic disk, optical disk drives, and/or solid-state memories, for storing data and instructions for use by the CPU 402. At least one component of the mass storage system 408, preferably in the form of a non-volatile disk drive, solid state, or tape drive, stores the database used for processing bids from advertiser clients and/or consumer client devices. The mass storage system 408 may also include one or more drives for various portable media, such as a floppy disk, flash drive, a compact disc read only memory (CD-ROM, DVD, CD-RW, and variants), memory stick, or an integrated circuit non-volatile memory adapter (i.e. PC-MCIA adapter) to input and output data and code to and from the computer system 400.

The computer system 400 may also include one or more input/output interfaces for communications, shown by way of example, as interface 410 and/or a transceiver for data communications via the network 412. The data interface 410 may be a modem, an Ethernet card or any other suitable data communications device. Data interface 410 may include a transceiver configured to send and receive data communications. To provide the functions of, for example, servers 302, 304, 306, 308 and/or 310 or arbitrator 314, arbitrator clients 316, 318, 320, and/or 322 according to FIG. 3, the data interface 410 may provide a relatively high-speed link to a network 412 and/or network 312, such as an intranet, internet, or the Internet, either directly or through another external interface. The communication link to the network 412 may be, for example, optical, wired, or wireless (e.g., via satellite or cellular network). The computer system 400 may also connect via the data interface 410 and network 412 to at least one other computer system to perform remote or distributed ad serving processing. Alternatively, computer system 400 may include a mainframe or other type of host computer system capable of Web-based communications via network 412. The computer system 400 may include software for operating a network application such as a web server and/or web client.

The computer system 400 may also include suitable input/output ports, that may interface with a portable data storage device, or use the interconnect bus 406 for interconnection with a local display 416 and keyboard 414 or the like serving as a local user interface for programming and/or data retrieval purposes. The display 416 may include a touch screen capability to enable users to interface with the system 400 by touching portions of the surface of the display 416. Computer system 400 may include one or more microphones and/or speakers to facilitate voice and/or audio communications with a user. Server operations personnel may interact with the system 400 for controlling and/or programming the system from remote terminal devices via the network 412.

The computer system 400 may run a variety of application programs and store associated data in a database of mass storage system 408. One or more such applications may include an ad and/or media content delivery server such as server 302 and/or server 502, or include ad servicing client such as arbitrator clients 316-322.

The components contained in the computer system 400 may enable the computer system to be used as a server, workstation, personal computer, network terminal, mobile computing device, mobile telephone, System on a Chip (SoC), and the like. As discussed above, the computer system 400 may include one or more applications such as machine learning (ML), deep learning, and artificial intelligence using neural networks. The system 400 may include software and/or hardware that implements a web server application. The web server application may include software such as HTML, XML, WML, SGML, PHP (Hypertext Preprocessor), CGI, and like languages.

The foregoing features of the disclosure may be realized as a software component operating in the system 400 where the system 400 includes Unix workstation, a Windows workstation, a LINUX workstation, or other type of workstation. Other operation systems may be employed such as, without limitation, Windows, MAC OS, and LINUX. In some aspects, the software can optionally be implemented as a C language computer program, or a computer program written in any high level language including, without limitation, Javascript, Java, CSS, Python, Keras, TensorFlow, PHP, Ruby, C++, C, Shell, C#, Objective-C, Go, R, TeX, VimL, Perl, Scala, CoffeeScript, Emacs Lisp, Swift, Fortran, or Visual BASIC. Certain script-based programs may be employed such as XML, WML, PHP, and so on. The system 200 may use a digital signal processor (DSP).

As stated previously, the mass storage 408 may include a database. The database may be any suitable database system, including the commercially available Microsoft Access database, and can be a local or distributed database system. A database system may implement Sybase and/or a SQL Server. The database may be supported by any suitable persistent data memory, such as a hard disk drive, RAID system, tape drive system, floppy diskette, or any other suitable system. The system 400 may include a database that is integrated with one or more servers of the systems 300 and/or 500, however, it will be understood that, in other implementations, the database and mass storage 408 can be an external element.

In certain implementations, the system 400 may include an Internet browser program and/or be configured operate as a web server. In some configurations, the client and/or web server may be configured to recognize and interpret various network protocols that may be used by a client or server program. Commonly used protocols include Hypertext Transfer Protocol (HTTP), File Transfer Protocol (FTP), Telnet, and Secure Sockets Layer (SSL), and Transport Layer Security (TLS), for example. However, new protocols and revisions of existing protocols may be frequently introduced. Thus, in order to support a new or revised protocol, a new revision of the server and/or client application may be continuously developed and released.

In one implementation, the system 300 and/or 400 includes a networked-based, e.g., Internet-based, application that may be configured and run on the server 302 and/or system 500 and/or any combination of the other components of the system 300 and/or 500. The server 302, server 502, and/or computer system 400 may include a web server running a Web 2.0 application or the like. Web applications running on systems 300 and/or 500 may use server-side dynamic content generation mechanisms such, without limitation, Java servlets, CGI, PHP, or ASP. In certain embodiments, mashed content may be generated by a web browser running, for example, client-side scripting including, without limitation, JavaScript and/or applets on a wireless device. In certain implementations, one or more computers and/or servers in system 300 and/or 500 may include applications that employ asynchronous JavaScript+XML (Ajax) and like technologies that use asynchronous loading and content presentation techniques. These techniques may include, without limitation, XHTML and CSS for style presentation, document object model (DOM) API exposed by a web browser, asynchronous data exchange of XML data, and web browser side scripting, e.g., JavaScript. Certain web-based applications and services may utilize web protocols including, without limitation, the services-orientated access protocol (SOAP) and representational state transfer (REST). REST may utilize HTTP with XML.

The computer 400, server 302, server 502, client devices 304-322, client devices 504 and 506, or another components of systems 300 and 500 may also provide enhanced security and data encryption. Enhanced security may include access control, biometric authentication, cryptographic authentication, message integrity checking, encryption, digital rights management services, and/or other like security services. The security may include protocols such as IPSEC and IKE. The encryption may include, without limitation, DES, 3DES, AES, RSA, ECC, and any like public key or private key based schemes.

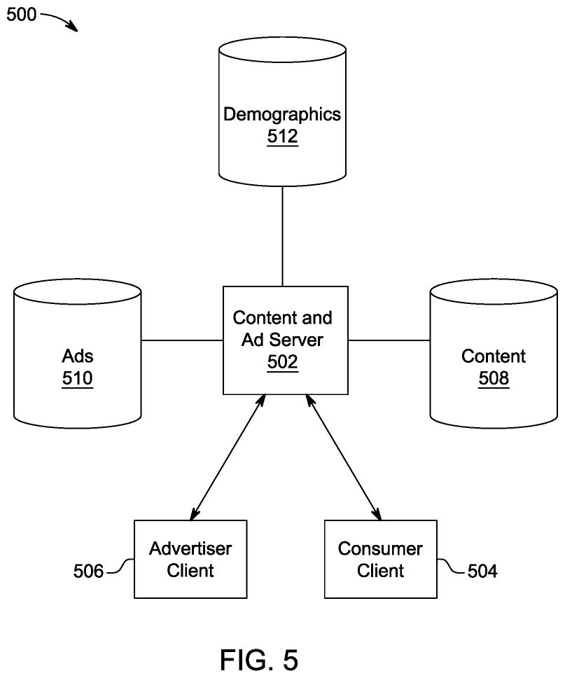

FIG. 5 is a block diagram of an Ad serving system 500 including a media content and Ad serving server 502, a consumer client device 504, an advertiser client device 506, a media content database 508, an Ads database 510, and a consumer demographics database 512. Media content and Ad server 502 may also be implemented by media content server 302. Content database 508 may include multiple media content items such as, without limitation, videos, movies, shows, podcasts, audio files, images, documents, articles, and so on. Ads database may include multiple electronic ads of varying durations and associated with different advertisers, products, and services. Advertiser client device 506 may operate in a similar manner as advertiser servers 304 and 306. Consumer client device 504 may operate in a similar manner as consumer client devices 308 and 310.

In a similar manner as system 300, system 500 may operate as an Ad serving system including media content and Ad server 502 that is arranged to: receive media content; receive an electronic advertisement from an advertiser such as via advertiser client device 506 and store the advertisement in Ad database 510; receive a consumer Ad payment limit from a consumer via consumer client device 504; and receive an advertiser Ad payment limit via advertiser client device 506. Media content server 502 may then compare the consumer Ad payment limit to the advertiser Ad payment limit and if the consumer Ad payment limit is greater than or equal to the advertiser Ad payment limit, then output the media content form media content database 508 without an Ad to the consumer client device 504 that requested the media content and made a the consumer bid, i.e., submitted the consumer Ad payment limit. If the consumer Ad payment limit is less than the advertiser Ad payment limit, then the media content server 502 outputs the media content from the media content database 508 with the electronic Ad from the Ad database 510. A consumer client device 504 may be arranged to: transmit the consumer Ad payment limit to the media content server 502, receive the media content from the media content database 508 via the media content server 502, and receive the electronic Ad with the media content when the consumer Ad payment limit is less than the advertiser Ad payment limit.

In some implementations, the consumer client device 504 may include a user interface arranged to enable a user and/or consumer to configure multiple consumer Ad payment limits with each limit being associated with a different Ad payment category such as, without limitation, a product, a service, a manufacturer, food producer, a vendor and/or advertiser, a technology, product category, and so on. For example, a consumer may input to the consumer client device a higher value for a consumer Ad payment limit for a first Ad payment category that the consumer is less interested in to ensure that it is more likely that any Ads associated with an undesirable category are more likely to be skipped or avoided. The consumer may set a lower or no consumer Ad payment limit for a category that the consumer is more likely to be interested so that it is more likely that an Ad in such as category is delivered and/or played with a media content item. For instance, a consumer who likes BMW automobiles, but not Audi automobiles, may configure a consumer Ad payment limit for BMW Ads at 0 cents, while setting a consumer Ad payment limit for Audi Ads at 20 cents. A consumer who is a vegan may set an Ad payment limit for Ads in the category of meat products to 30 cents and set an Ad payment limit for Ads in the category of vegetarian products at 10 cents. The consumer client device 504 may send one or more consumer Ad payment limits based on different Ad payment categories to the media content server 502, 302, and/or arbitrator 314.

In certain implementations, an advertiser may use consumer demographic data such as in database 512 to increase the likelihood that certain target consumers will be delivered their Ads. For example, Rolex may set a higher advertiser Ad payment limit for older, wealthier, and more educated males, that have purchased expensive watches previously to increase the likelihood that this demographic is delivered their Ad with a media content item. Hence, an advertiser client device 506 may send multiple different advertiser Ad payment limits to media content server 502, server 302, and/or arbitrator 314 to be associated with different demographics of consumers that the advertiser prefers to target with their Ads.

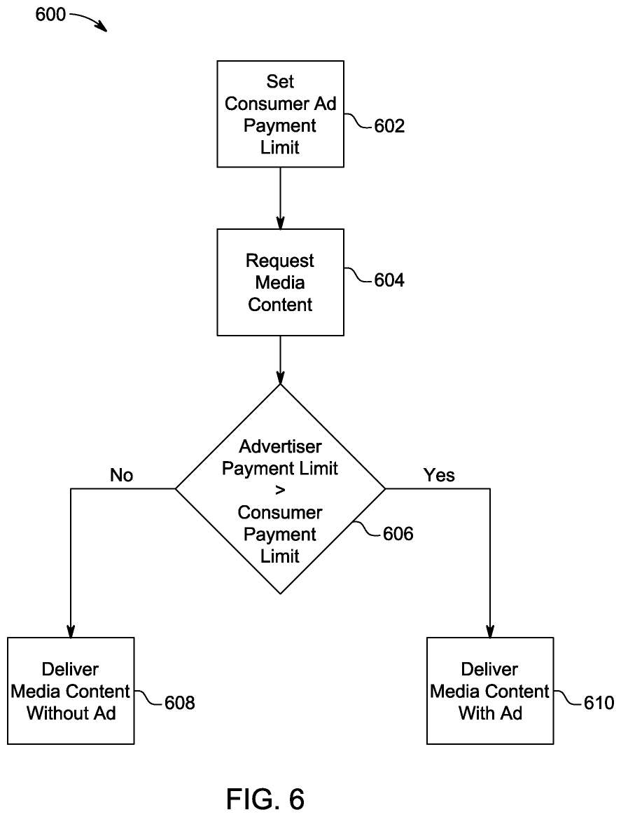

FIG. 6 shows an exemplary process 600 for determining whether to output media content with an electronic advertisement. Process 600 includes: setting a consumer Ad payment limit (Step 602), requesting media content from a media content server 302 and/or 502 (Step 604), comparing the consumer Ad payment limit to an advertiser Ad payment limit (Step 606). If the advertiser Ad payment limit is greater than the consumer Ad payment limit, then deliver the media content with the advertisement to a consumer client device 308, 310, and/or 504 to be played with the media content (Step 610). If the advertiser Ad payment limit is not greater that the consumer Ad payment limit, then deliver the media content with the advertisement to the consumer client device 308, 310, and/or 504. In certain implementations, Step 606 is repeated as a the consumer client device 308, 310, and/or 504 and advertiser device 304, 306, and/or 506 bid and counter-bid their Ad payment limits until one of the parties wins the bidding process.

It will be apparent to those of ordinary skill in the art that certain aspects involved in the operation of the system 300 or system 500, servers 302 and 502, and other devices such as devices 304-310, 504, and 506 may be embodied in a computer program product that includes a computer usable and/or readable medium. For example, such a computer usable medium may consist of a read only memory device, such as a CD ROM disk or conventional ROM devices, or a random-access memory, such as a hard drive device or a computer diskette, or flash memory device having a computer readable program code stored thereon.

Elements or steps of different implementations described may be combined to form other implementations not specifically set forth previously. Elements or steps may be left out of the systems or processes described previously without adversely affecting their operation or the operation of the system in general. Furthermore, various separate elements or steps may be combined into one or more individual elements or steps to perform the functions described in this specification.

Other implementations not specifically described in this specification are also within the scope of the following claims.

What is claimed is:

1. An advertisement (Ad) serving system comprising:
a media content server arranged to:
receive media content from a media database;
receive an electronic advertisement from an advertisement database;
receive a consumer Ad payment limit;
receive an advertiser Ad payment limit;
compare the consumer Ad payment limit to the advertiser Ad payment limit and when a second advertiser Ad payment limit is not received:
if the consumer Ad payment limit is greater than or equal to the advertiser Ad payment limit, then output the media content, and
if the consumer Ad payment limit is less than the advertiser Ad payment limit, then output the media content with the electronic advertisement; and
a consumer client device arranged to:
transmit the consumer Ad payment limit to the media content server,
receive the media content from the content server, and
receive the electronic advertisement with the media content when the consumer Ad payment limit is less than the advertiser Ad payment limit.

2. The system of claim 1, wherein the media content server includes a web server.

3. The system of claim 2, wherein the consumer client device includes a web client.

4. The system of claim 1 comprising an advertiser server configured to send at least one of the advertiser Ad payment limit and the second advertiser Ad payment limit to the media content server.

5. The system of claim 4, wherein the advertiser server is configured to receive the consumer Ad payment limit from the media content server.

6. The system of claim 5, wherein the advertiser server sends the second advertiser Ad payment limit to the media content server in response to the received consumer ad payment limit.

7. The system of claim 5, wherein the consumer client device is configured to receive the advertiser Ad payment limit from the media content server.

8. The system of claim 7, wherein the consumer client device sends a second consumer Ad payment limit to the media content server in response to the received advertiser Ad payment limit.

9. The system of claim 8, wherein the second consumer Ad payment limit is greater than the received advertiser payment limit.

10. The system of claim 6, wherein the second advertiser Ad payment limit is greater than the consumer Ad payment limit.

11. A media content server comprising:
a transceiver arranged to:
receive media content from a media database,
receive an electronic advertisement from an advertisement database,
receive a consumer Ad payment limit from a consumer client device, and
receive an advertiser Ad payment limit from an advertising server,
a processor, in communications with the transceiver, arranged to:
compare the consumer Ad payment limit to the advertiser Ad payment limit and when a second advertiser Ad payment limit is not received:
if the consumer Ad payment limit is greater than or equal to the advertiser Ad payment limit, then output the media content to the consumer client device, and
if the consumer Ad payment limit is less than the advertiser Ad payment limit, then output the media content with the electronic advertisement to the consumer client device.

12. The server of claim 11, wherein the media content server includes a web server.

13. The server of claim 12, wherein the consumer client device includes a web client.

14. The server of claim 11, wherein the transceiver is configured to receive the second advertiser Ad payment limit from the advertiser server.

15. The server of claim 14, wherein the transceiver is configured to send the consumer Ad payment limit to the advertiser server.

16. The server of claim 15, wherein the transceiver receives the second advertiser Ad payment limit in response to sending the consumer ad payment limit to the advertiser server.

17. The server of claim 15, wherein the media content server is configured to send the advertiser Ad payment limit to the consumer client device.

18. The server of claim 11, wherein the consumer Ad payment limit is set based on a first Ad payment category and a second consumer Ad payment limit is set based on a second Ad payment category.

19. The server of claim 11, wherein the advertiser Ad payment limit is set based on consumer demographic data.

20. A non-transient computer readable medium containing program instructions for causing a computer to implement advertisement (Ad) serving comprising the method of:
receiving media content from a media database;
receiving an electronic advertisement from an advertisement database;
receiving a consumer Ad payment limit from a consumer client device;
receiving an advertiser Ad payment limit from an advertiser server; and
comparing the consumer Ad payment limit to the advertiser Ad payment limit and when a second advertiser Ad payment limit is not received:
if the consumer Ad payment limit is greater than or equal to the advertiser Ad payment limit, then outputting the media content, and
if the consumer Ad payment limit is less than the advertiser Ad payment limit, then outputting the media content with the electronic advertisement.
